(19) United States
(12) Patent Application Publication
(10) Pub. No.: US 2021/0310793 A1
(43) Pub. Date: Oct. 7, 2021

(54) DEVICE FOR MEASURING MORPHOLOGICAL LENGTH, BASED ON ANGULAR LASER TECHNIQUE (ALT), AND ASSOCIATED METHOD

(71) Applicant: UNIVERSIDAD CES., Medellin (CO)

(72) Inventors: Luis Esteban ALZATE BASTO, Medillin (CO); Diego Alejandro ORTIZ MEJÍA, Medellin (CO); David VANEGAS GIRALDO, Envigado (CO)

(73) Assignee: UNIVERSIDAD CES., Medellin (CO)

(21) Appl. No.: 17/261,487

(22) PCT Filed: Jul. 18, 2019
(86) PCT No.: PCT/IB2019/056169

§ 371 Date: Jan. 19, 2021

(30) Foreign Application Priority Data
Jul. 19, 2018 (CO) NC2018/0007596

(51) Int. Cl. G01B 11/02; G01B 11/26

(52) U.S. Cl. CPC G01B 11/02; G01B 11/26

(57) ABSTRACT

The present invention relates to a device for carrying out a process of measuring morphological lengths using an angular laser technique (ALT). The device of the present invention comprises a main case or box defined by two sections joined together by a pivot point, so that a first section can turn or rotate with respect to a second section, and inside of which is contained a laser distance meter for measuring using photon return, an accelerometer, a data processor, a display element, a potentiometer or resistance adjuster, a series of operation buttons or switches, and a power supply system such as a battery or similar. The invention also relates to a method for measuring using the defined device.

### TECHNICAL FIELD

The present invention relates to a device for carrying out a process of measuring morphological lengths using an angular laser technique (ALT), whereby the present disclosure describes a measuring element and a process by which such measurement is reached using specifically the measurement element. The device of the present invention comprises a main case or box defined by two sections joined together by a pivot point, so that a first section can turn or rotate with respect to a second section, and inside of which is contained a laser distance meter for measuring using photon return, an accelerometer, a data processor, a display element, a potentiometer or resistance adjuster, a series of operation buttons or switches, and a power supply system such as a battery or similar.

### STATE OF THE ART

Currently, morphological measurements of irregular shapes require quite complex devices and processes that in turn require the use of quite expensive techniques and qualified personnel to obtain an adequate and accurate measurement. This fact is totally undesirable and therefore represents a clear need in the art.

Thus, in the state of the art there is a plurality of disclosures related to devices to carry out some type of length measurement by means of laser technology, among which there is the document U.S. Pat. No. 7,350,303 which describes a horizontal and vertical level, angle and distance measuring device suitable for indicating when two or more points are level with each other and for measuring distances and angles between two or more points, a point and a line or a point and a plane. The measuring device includes a measuring point to identify from where measurements are to be calculated, a user-activated actuator, and a screen to display measurements to the user, either in real time or in a memory mode. The device specifically comprises a housing (outer case), a power supply, one or more sensors detecting six degrees of freedom, a processor, an activator button, and a display screen. The device further comprises a plurality of motion sensors comprising at least three accelerometers and three angular rate sensors.

However, this disclosure has the disadvantage that although it is related to a device for measuring distances or lengths using lasers and sensors to detect said laser, as well as accelerometers for tilt measuring, wherein all the information is displayed on a screen and can be manipulated by means of activation buttons and display modes, the above only mentions that it has a case or box to include all the elements therein, wherein said box is a fixed and static element, which does not rotate and does not allow a proper alignment between the sensor and the accelerometer in order to obtain the measurement in the most adequate and accurate way.

On the other hand, U.S. Pat. No. 7,568,289 discloses a handheld measurement device including a distance measurement engine and an angular position measurement engine, wherein a controller controls such measurement engines and associates an elevation, azimuth position, or relative angular position with distance measurements taken from the elevation engine. Likewise, the device has an algorithm stored in a memory for calculating measurements that depend on the distance measurements of said position engine. In addition, it includes a user interface that may correspond to a screen to display the measurements taken from a target. In addition to the above, the device has an accelerometer in the angular position motor, which is mounted on a common rigid substrate with said distance measurement engine.

However, the foregoing has the disadvantage, like the previously defined document, that it makes use of a static and fixed box, without pivot points or movement axes, so it is not possible to perform the proper alignment of the accelerometer and the laser meter and thus have freedom of movement, therefore it can be concluded that the measurement is not accurate and, therefore, it is totally undesirable.

Now, within the state of art, US 2011288818 also describes a non-contacting measurement apparatus for measuring distances, angles and related geometric quantities. Thus, a visible light beam or ultrasonic beam allows a user to point the device at one or more points to which the distance is measured, and angular rotation between the various points of interest can be measured and recorded. In this way, the device comprises a housing suitable for a human user to grip and carry the apparatus thereby; a coherent light source that can be directed in a first direction so as to shine the distance to be measured; a distance measurement element; an angular displacement or rotational sensing element determining a specific angle; a data storage element; a processor that receives a plurality of inputs from the sensors; a display unit that provides the user the operational features and measurements information; and a user interface adapted to receive inputs from said user to control the operation of said apparatus.

However, the technology described therein is based on a measurement element without the use of accelerometers for the angular position, which may lead to inconsistencies or errors in the measurements, while the case or external box is simple, without pivot points or different sections, which further increase the likelihood of measurement errors.

In addition to the above, CN 106093468 discloses an angular acceleration measurement device that may reduce calibration and time costs when using an accelerometer to measure angular acceleration, wherein the device comprises two flexible quartz accelerometers mounted in parallel along a sensitive axis, the distance between the centers of mass of the accelerometers is obtained by calibration by means of a precise angular vibrating table.

However, like the previous disclosed document, this document has the disadvantage that it does not specifically mention linear distance or the measurement thereof, but focuses on angular acceleration measurement (in motion), while making use of a fixed and simple external box or case, without divisions or pivoting points; likewise, it does not have any interaction element with the user, which does not enable it to be controlled in any way but to be limited to the pre-established configuration.

Finally, US 2017097235 describes a non-contact measurement apparatus to measure an orientation of two or three dimensions in a plane with respect to a point on a flat surface and/or two dimensions with respect to a curved surface, wherein the measuring apparatus comprises a plurality of distance measuring elements, a processor capable of measuring any amount of information supplied, an input device that converts the output signal into an output format that is used by a user to know the information, a power supply that may be portable, a connection circuit that performs one or more of the functions of encapsulating signals or related to power, and a support, wherein the support comprises any combination of a physical cover, device, fastener, and/or component that may be used to support and/or arrange one or more components of the measuring apparatus.

However, as with some of the prior art documents mentioned above, this approach has the disadvantage that it does not specifically mention the use of accelerometers, so that the measurements obtained may be subject to errors or inconsistencies, while it is based on a fixed and simple box or case, without pivoting portions, so that it is not possible to align the laser and further elements for more adequate and/or accurate measurements.

Similarly, in the art there is the disclosure “A simple optical device for measuring free surface deformations of nontransparent liquids”, Journal of Colloid and Interface Science, Volume 288, Issue 2, Aug. 15, 2005, Pages 508-512, which is a scientific document that relates to an optical device for measuring the deformation of liquid-free surfaces, wherein the device uses a beam laser, which can be focused on any selected location. The optics is designed to measure a maximum intensity when the distance between the lens and the selected point is equal to the focal length, thus allowing a height measurement. The device then focuses on the measurement of ferrofluid pools where the height of the peaks of normal field instability is measured.

From the definitions in the previous paragraphs, it can be clearly seen that there is a plurality of disclosures that define a device or apparatus for measuring distances or lengths based on beam laser and a series of sensors detecting the intensity of reflection of said beam in order to determine the length from a starting point to an end point, wherein all state-of-the-art devices have an outer case or box, a keyboard or input device and an output device to display information to a user, but wherein said cases or boxes are totally fixed or static elements that have no movement and therefore do not allow adequate alignment of the laser with the accelerometer in order to obtain the most appropriate and accurate measurement.

According to the above information, for a person skilled in the art it is evident that there is a need to design and implement a device for the measurement of lengths, specifically morphologies in living beings, wherein the device allows to perform the measurements of parts of the living being having a totally irregular shape, through the use of a series of laser sensors and accelerometers that enable the accurate and adequate measurement, while mobile elements are required to make an alignment between said sensors and accelerometers so that these elements are always in the same plane and thus, the purpose of appropriate measurement may be achieved.

### SUMMARY OF THE INVENTION

In a first aspect, the present invention relates to a device for measuring lengths by means of an angular laser technique (ALT), which is a new methodology for obtaining a particular length, where said technique is based on functions and trigonometric relations to calculate, with two measurements provided by a laser distance unit and the angle provided by the accelerometer, the length of an individual or a particular morphological measure.

Additionally, this calculated length may be used for extrapolation of the initial length to other morphometric measurements. Thus, once all the devices are in operation, the following steps are followed to obtain the measurement:

the device aims to collect four data in order to obtain LC, the data are the followings: Distance 1, which is the distance between the device and the initial measurement point; Position 1 (A), which consists of a point in a circular space (1); Distance 2 (B), which is the distance between the device and the back side of the cranial table; and finally, Position 2 (2), which is the second position marked by the device.

Thus, the absolute value of the subtraction of Position 1 and 2 will result in the angle between Distance 1 and 2. What is sought with the use of these distances and the angle is to apply trigonometric relations of a triangle to find a cathetus, which in this case would be the partial or total length of an individual.

Internally, the device is programmed to perform these calculations automatically, therefore, in this protocol only the internal procedure of the device is indicated, with the advantage that the operator of said device does not have to perform any calculations.

In a preferred embodiment, the present invention is based on a device as previously defined, which primarily consists of a custom-made outer box or case, inside which five basic components are housed, among these there are both commercial and open hardware devices. Their internal units and housed inside the case or box are: a laser distance meter, a one to three axis accelerometer, a data processing unit, a display element, operation buttons and a power supply, such a battery.

In an even more preferred embodiment, the box or outer case is a custom-made element and has two main parts or portions, which are coupled to each other by means of an axis called a pivot point which enables the movement thereof one related to the other. This movement is possible since the first portion of the case has a pin just on the rotation axis of the accelerometer and this is inserted into a hole in the other portion of the case, which enables the movement of the first portion on the axis.

With the rotation of the first portion of the case with respect to the second portion, the main feature is that it enables both the laser distance meter and the accelerometer to be aligned on the same axis and in addition, the electronic components are protected such as cabling and data processors.

In another embodiment, the present invention relates to a method for measuring a distance, preferably the morphology of a living being, by applying or using the aforementioned device, wherein said method is based on the location of the device in the same measurement plane to be taken. Then, proceed to the measurement of (A) using the laser meter and record the value of this distance and that of the position using the operating buttons. Then, the upper part of the device is moved until the laser is at Position 2. (B) is measured and recorded together with (2). After the above steps, you will have (A), (B), (1) and (2) and the device will display the desired length. To carry out the extrapolation of the measurements, the device will take an already established formula and will show this result on the screen along with the initially measured length.

Calculation formulas:

angle between distances: α={square root over (([(1)−(2)]\hat{ }2))}

Formula for length:

L_{ATL}={square root over (([A)\hat{ }2+(B)\hat{ }2−2(A)(B)Cos α]))}

Correction of bias according to target distance (T.D)

L_{correction}=LC_{ALT}−(−0.00134×0.002×T.D)

Throughout the description and the claims, the word “comprise” and variants thereof are not intended to exclude other technical characteristics, additives, components or steps. For those skilled in the art, other objects, advantages and features of the invention will arise partly from the description and partly from the practice of the invention. The following examples and figures are provided by way of illustration, and are not intended to limit the present invention.

### BRIEF DESCRIPTION OF THE FIGURES

The present invention is more clearly understood from the following figures where the different components, parts or steps associated with the present device, apparatus, system or method are shown, as well as the novel elements with respect to the state of the art, wherein, the figures are not intended to limit the scope of the invention, which is solely determined by the appended claims, wherein:

FIG. 1 corresponds to a perspective view of the device of the present invention, wherein the rotation or pivot point between the first upper portion and the second lower portion of the outer case or box is shown.

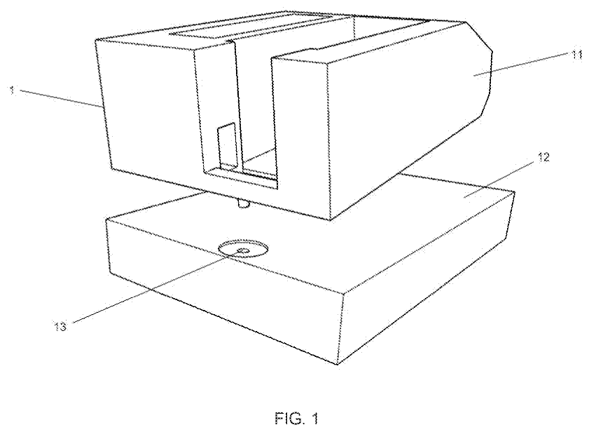

FIG. 2 corresponds to a top view of the upper portion and the lower portion of the device.

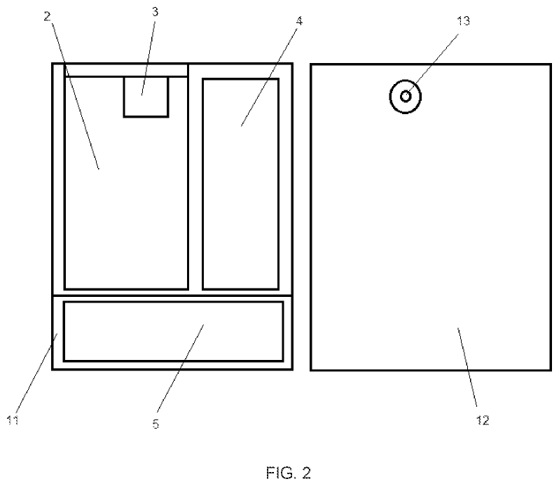

FIG. 3 corresponds to the side view of the device, wherein the upper and lower portions can be seen.

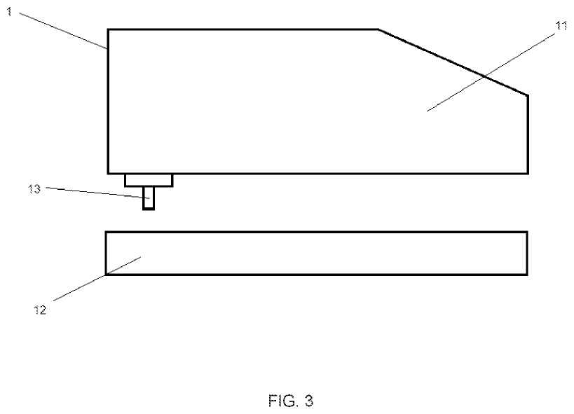

### DETAILED DESCRIPTION OF THE INVENTION

Then, the present invention and the best way to carry it out will be defined, wherein the best embodiments thereof are included, which should be understood as broadly as possible without limitations.

In this sense, the present invention is mainly directed to a device for measuring morphological lengths using an angular laser technique (ALT), which comprises the following components or parts:
A box or outer case (1) comprising a first upper section (11) and a second lower section (12), wherein said sections are joined together at a pivot point (13) enabling them to rotate in relation to each other, and inside of which all the elements that are part of the present device are located.
A laser distance meter (2) that corresponds to a component that measures the distance between the device of the invention and a fixed point, through the photon return, wherein said distance meter (2) is located within the upper section (11) of the box or outer case (1).
An accelerometer (3) whose operation is 1 to 3 dimensional axes and is compatible with any open hardware device, and is responsible for measuring the angle between the distance between the device and the measuring point and the device and the back side of the object to be measured, wherein said accelerometer (3) is located within the lower section (12) of the box or outer case (1).
A data processor (4) which corresponds to a control element that controls the operation of all the other elements and that of the device of the invention, wherein said processor preferably enables the laser meter (2) and the accelerometer (3) to be turned on, the calibration of the components, and the processing and data calculation obtained after carrying out the distance measurements.
A display element (5) which preferably corresponds to a screen that is compatible with the data processor (4), wherein said screen may preferably be of the touch type.
A potentiometer compatible with the display element (5) and which has a minimum resistance characteristics of 10 kΩ.
Operation buttons compatible with the data processor (4), by means of which the operation of the device may be controlled and which enable the user to take appropriate measurements. Furthermore, these buttons correspond to the interface with the user, so they are also used to configure the elements of the device of the present invention.
A power supply, which corresponds to the module that supplies power to the device in a complete way, wherein said power supply is preferably of a removable type, such as a commercial battery, and preferably it has a minimum operating voltage of 9 V in DC, although lower voltages are also contemplated according to the operating conditions of the elements of the invention, previously defined.

Thus, in one embodiment of the invention, the laser distance meter (2) is a commercially available component, whose minimum features for operation in the device of the invention are: minimum distance range of 40 m; device standard error±2 mm or less.

In the same way, it is preferred that the data processor (4) has operating features whose minimum specifications must be: operating voltage: 5 V, flash memory: 32 KB, SRAM: 2 KB, dock speed: 16 MHz, analog inputs: 8; digital inputs: 8 to 12.

On the other hand, all components are connected to each other by cables, as may be dear and evident to a person skilled in the art, wherein the material of said cables may vary according to the conductivity needs required, but wherein said modification is contemplated within the present invention.

In a preferred embodiment, the box or outer case (1) is made of a high-strength and preferably low-weight material.

Now, the present invention is also directed to a method for measuring a distance by means of the device defined above, wherein said method comprises the steps of:
a) Place the device on the same plane as the measurement to be taken;
b) Take distance 1 between the device and the initial measurement point by means of a laser meter;
c) Determine the position A, which consists of a point in a circular space;
d) Take distance 2 between the device and the back side of the cranial table of the device to be measured;
e) Determine position B, which is the second position marked by the device, when moving the upper part (11) of the device;
f) Subtract positions 1 and 2 to obtain the angle between distance 1 and 2;
g) Upon having the values of A, B, 1 and 2, view the information obtained on the screen (5);
h) Extrapolate the measurements from the following equations:

angle between distances α={square root over (([(1)−(2)]\hat{ }2))}

Length: L_{ALT}={square root over (([A)\hat{ }2+(B)\hat{ }2−2(A)(B)Cos α]))}
i) Show the results of the calculations in the display element.

This description heretofore corresponds to one or more embodiments of the present invention and does not pretend to limit the scope of this application, as established and defined in the attached set of claims.

1. A device for measuring morphological lengths using an angular laser technique (ALT), comprising:
a box or outer case comprising a first upper section and a second lower section, wherein said sections are joined together at a pivot point being each of the sections and independent from each other, and inside of which all the other elements are located;
wherein the first section and the second section enable the sensors to rotate with respect to a fixed rotation point;
wherein the pivot point is a stem that fits into the second section and said stem passes just over the rotation axis of the accelerometer;
a laser distance meter of photon return, wherein said distance meter is located within the upper section of the box or outer case;
an accelerometer with 1 to 3 dimensional axes, wherein said accelerometer is located within the lower section of the box or outer case and the rotation axis of the accelerometer is aligned with the stem of the pivot point;
a data processor connected with the other elements of the device;
a display element which is a screen compatible with the data processor and is of the touch type;
a potentiometer compatible with the display element, which modifies the contrast of the screen;
input interface compatible with the data processor wherein the input interface corresponds to operation buttons; and
a power supply, which is removable such as a battery.

2. The device of claim 1, wherein the laser distance meter has a minimum distance range of 40 m, and standard error±2 mm or less.

3. The device of claim 1, wherein the display element is a screen compatible with the data processor.

4. The device of claim 3, wherein the digital display is a touch type display.

5. The device of claim 1, wherein the input interface corresponds to operation buttons.

6. The device of claim 1, wherein the power supply is a removable battery.

7. The device of claim 1, wherein the elements are connected to each other by means of connection cables.

8. A method for measuring distances, comprising:
placing the device on the same plane as the measurement to be taken;
taking distance 1 between the device and the initial measurement point by means of a laser meter;
determining the position A, which consists of a point in a circular space;
taking distance 2 between the device and the back side of the cranial table of the device to be measured;
determining position B, which is the second position marked by the device, when moving the upper part of the device;
subtracting positions 1 and 2 to obtain the angle between distance 1 and 2;
upon having the values of A, B, 1 and 2, viewing the information obtained on the screen;
extrapolating the measurements from the following equations:
angle between distances α={square root over (([(1)−(2)]\hat{ }2))}
Length: LALT={square root over (([A)\hat{ }2+(B)\hat{ }2−2(A)(B)Cos α]))}
displaying the results of the calculations in the display element.
